(19) United States
(12) Patent Application Publication
(10) Pub. No.: US 2026/0170778 A1
(43) Pub. Date: Jun. 18, 2026

(54) WEB-BASED VIEWER AND EDITOR FOR 3-D SCENE REPRESENTATIONS

(71) Applicants: Sony Group Corporation, Tokyo (JP); Sony Pictures Entertainment Inc., Culver City, CA (US)

(72) Inventors: Nikola Dordic, Vancouver (CA); Dusan Svilarkovic, AP Vojvodina (RS); Mahmoud Rahnama, Toronto (CA)

(21) Appl. No.: 19/214,702

(22) Filed: May 21, 2025

Related U.S. Application Data
(60) Provisional application No. 63/734,569, filed on Dec. 16, 2024.

(51) Int. Cl. G06T 19/20; G06T 7/11; G06T 15/08; G06T 15/20; G06T 19/00

(52) U.S. Cl. CPC G06T 19/20; G06T 7/11; G06T 15/08; G06T 15/20; G06T 19/003; G06T 2200/24; G06T 2207/20104; G06T 2219/2012

(57) ABSTRACT

Selecting 3-D shapes in a 3-D scene representation for segmentation model, including: receiving parameters including virtual camera pose, 3-D scene view, and viewport location of the 3-D shapes including an object of interest; performing segmentation of the object of interest using the 3-D scene view and the viewport location of the object of interest; extracting a 2-D view of the object of interest using the segmented object of interest; performing segmentation of memory state of the extracted 2-D view; generating 3-D virtual camera poses around the object of interest using the extracted 2-D view and the virtual camera pose; performing segmentation of the object of interest using the 3-D scene views, the segmented memory state of the extracted 2-D view, and the 3-D virtual camera poses; and extracting multiple 2-D views of the object of interest using the segmented object of interest.

### CROSS-REFERENCE TO RELATED APPLICATIONS

This application claims the benefit of priority under 35 U.S.C. § 119(e) of co-pending U.S. Provisional Patent Application No. 63/734,569 , filed Dec. 16, 2024, entitled “Web-based Viewer and Editor of Realistic Gaussian Splatting Representations”. The disclosure of the above-referenced application is incorporated herein by reference.

### BACKGROUND

### Field

The present disclosure relates to web-based viewer and editor, and more specifically to web-based viewer and editor for realistic 3-D scene representations.

### Background

Currently, computing devices including laptops and mobile phones can render 3-D scenes. Certain renderings that were only possible on game consoles can now be rendered in web browsers using native functionalities of the browser. Thus, web designers often embed 3-D scenes into their websites and web pages. Accordingly, a need exists for web-based renderers that can provide a bridge between the web design environments and the 3-D code design environments.

### SUMMARY

The present disclosure provides for web-based viewer and editor for selecting 3-D shapes in a 3-D scene representation for segmentation model.

In one implementation, a method for selecting 3-D shapes in a 3-D scene representation for segmentation model is disclosed. The method includes: receiving parameters including virtual camera pose, 3-D scene view, and viewport location of the 3-D shapes including an object of interest; performing segmentation of the object of interest using the 3-D scene view and the viewport location of the object of interest; extracting a 2-D view of the object of interest using the segmented object of interest; performing segmentation of memory state of the extracted 2-D view; generating 3-D virtual camera poses around the object of interest using the extracted 2-D view and the virtual camera pose; performing segmentation of the object of interest using the 3-D scene views, the segmented memory state of the extracted 2-D view, and the 3-D virtual camera poses; and extracting multiple 2-D views of the object of interest using the segmented object of interest.

In another implementation, a web-based viewing apparatus to select 3-D shapes in a 3-D scene representation for segmentation model is disclosed. The apparatus including: a segmentation system to receive rendered 3-D scene view and viewport location of the 3-D shape including an object of interest, and to perform segmentation of the object of interest using the rendered 3-D scene and the viewport location, the segmentation system to extract and output a 2-D view of the object of interest using the segmented object of interest; a 3-D virtual camera pose generator to generate 3-D virtual camera poses around the object of interest using the extracted 2-D view; and a pose renderer to render the generated 3-D virtual camera poses and to output 3-D scene views, wherein the segmentation system receives the 3-D scene views and extracts multiple 2-D views of the object of interest using the 3-D scene views and the 3-D virtual camera poses.

In yet another implementation, a method for selecting 3-D shapes including an object of interest in Gaussian splatting representation is disclosed. The method includes: performing segmentation of the object of interest of the 3-D shapes using 3-D scene view and viewport location of the object of interest; extracting a 2-D view of the object of interest using the segmented object of interest; performing segmentation of memory state of the extracted 2-D view; generating 3-D virtual camera poses around the object of interest using the extracted 2-D view; performing segmentation of the object of interest using the 3-D scene views, the segmented memory state of the extracted 2-D view, and the 3-D virtual camera poses; and extracting multiple 2-D views of the object of interest using the segmented object of interest.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow diagram of a method for a web-based viewer to perform 3-D selection of shapes in a 3-D scene representation for segmentation model in accordance with one implementation of the present disclosure; and

FIG. 2 is a block diagram of an application residing on a hardware mobile device for a web-based viewer to perform 3-D selection of shapes in a 3-D scene representation for segmentation model in accordance with one implementation of the present disclosure.

### DETAILED DESCRIPTION

As described above, websites and web pages may often include embedded 3-D scenes resulting in a need for web-based renderers. Certain implementations of the present disclosure provide for web-based viewer and editor (hereinafter referred to as “web-based viewer”) for realistic 3-D scene representations including Gaussian splatting representations, which works as a renderer and a user interface for manipulation of the grouped splat representations. By using tools integrated in the interface, a user is able to extract semantically grouped shapes from the non-semantic 3-D representation, clone them, manipulate them and remove them if needed. The viewer may also offer importing, adding and removing customized animated camera views of the scene and rendering them. In addition to editing the splats, the final edited representation may also be exported in the same format in which it was imported, with updated changes.

After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

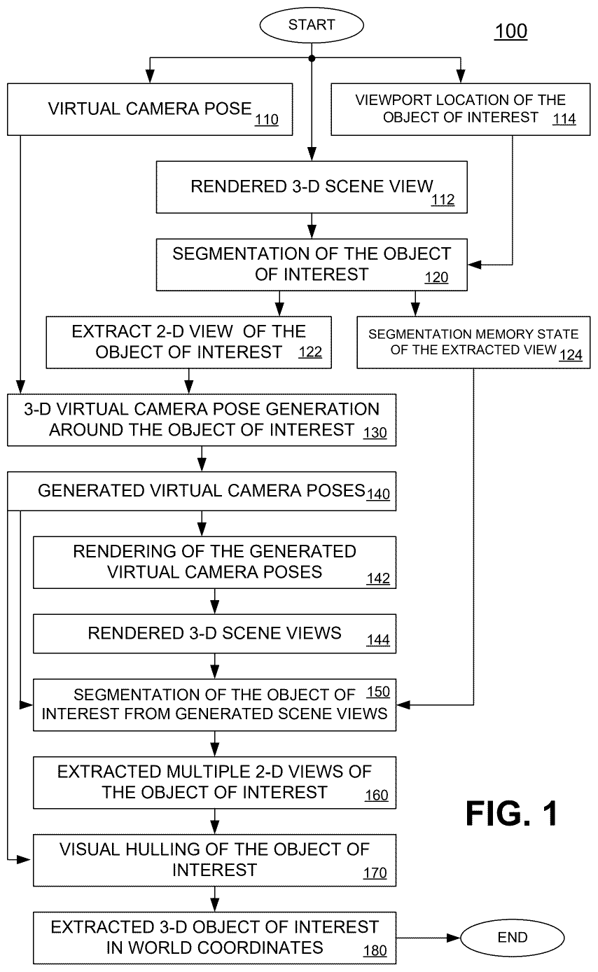

FIG. 1 is a flow diagram of a method 100 for a web-based viewer to perform 3-D selection of shapes in a 3-D scene representation for segmentation model in accordance with one implementation of the present disclosure. In one implementation, the web-based viewer is a standalone web application. In one implementation, the web application resides on a hardware mobile device for real-time visualization, editing and navigation throughout 3-D representations.

In the illustrated implementation of FIG. 1, the viewer receives parameters including virtual camera pose 110, rendered 3-D scene view 112, and viewport location of the object of interest 114. Segmentation of the object of interest is performed, at step 120, using the rendered 3-D scene view 112 and the viewport location of the object of interest 114. A 2-D view of the object of interest is extracted, at step 122. A segmentation of memory state of the extracted view is also performed, at step 124.

In one implementation, 3-D virtual camera poses are generated, at step 130, around the object of interest using the extracted 2-D view (at step 122) and the virtual camera pose 110. Then, the generated 3-D virtual camera poses are received, at step 140, and are used, at step 142, to render the generated 3-D virtual camera poses. Further, 3-D scene views are generated and rendered, at step 144, and segmentation of the object of interest are performed, at step 150, using (1) the generated 3-D scene views, (2) segmented memory state of the extracted view obtained at step 124, and (3) the virtual camera poses generated at step 140.

In one implementation, the method 100 also includes extracting multiple 2-D views of the object of interest, at step 160, and visual hulling the object of interest, at step 170. Finally, the 3-D objects of interest in world coordinates are extracted, at step 180.

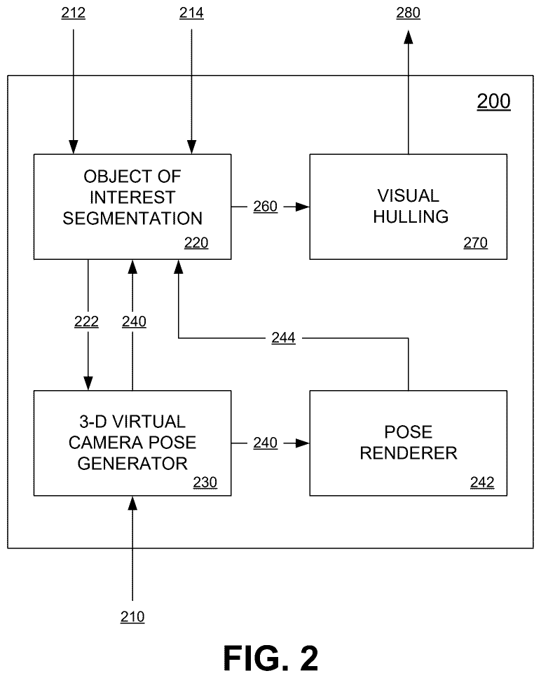

FIG. 2 is a block diagram of an application residing on a hardware mobile device for a web-based viewer 200 to perform 3-D selection of shapes in a 3-D scene representation for segmentation model in accordance with one implementation of the present disclosure. In one implementation, the web-based viewer is a standalone web application. In one implementation, the web application resides on a hardware mobile device for real-time visualization, editing and navigation throughout 3-D representations.

In the illustrated implementation of FIG. 2, the viewer 200 includes an object of interest segmentation system 220, a 3-D virtual camera pose generator 230, a poses renderer 242, and a visual hulling system 270.

In the illustrated implementation of FIG. 2, the viewer 200 receives parameters including virtual camera pose 210, rendered 3-D scene view 212, and viewport location of the object of interest 214. In one implementation, the Virtual camera pose 210 is received by the 3-D virtual camera pose generator 230, while the rendered 3-D scene view 212 and the viewport location of the object of interest 214 are received by the object of interest segmentation system 220.

In one implementation, the object of interest segmentation system 220 performs segmentation of the object of interest, extracts and outputs a 2-D view of the object of interest 222. The segmentation system 220 also generates a segmentation of memory state of the extracted view internally.

In one implementation, the 3-D virtual camera pose generator 230 receives the extracted 2-D view 222 and the virtual camera pose 210 and generates 3-D virtual camera poses around the object of interest. Then, the generated 3-D virtual camera poses 240 are input to the pose renderer 242 to render the generated 3-D virtual camera poses. In one implementation, the poses renderer 242 generates and renders 3-D scene views 244. Further, the segmentation system 220 generates and/or extracts multiple 2-D views of the object of interest 260 using the generated 3-D scene views 244, the segmented memory state of the extracted view internally generated, and the virtual camera poses 240. In one implementation, the visual hulling system 270 performs visual hulling of the object of interest and extracts 3-D objects of interest in world coordinates 280.

In operation, the above-described implementations may provide one or more of: (a) web viewing of 3-D scenes in various representations; (b) semantic object selection on the 3-D scene; (c) dragging object selection; (d) cloning object selection; and (e) virtual camera manipulation and rendering.

In one implementation, web viewing of 3-D scenes in various representations includes: (a) loading 3-D scenes through the specified paths; (b) navigating in real-time throughout the 3-D scene views; (c) toggling change between color, depth and normal representation through underlying 3-D scenes; (d) defining color complexity levels used for 3-D visualization when splats used in the Gaussian splatting representation are based on different color representations; (e) manipulating the 3-D scenes including select, move, clone and delete objects; and (f) exporting the manipulated 3-D scenes.

In one implementation, selecting the semantic object on the 3-D scene includes: (a) loading the 3-D scenes through the specified path; (b) navigating in real-time throughout the 3-D scenes; (c) finding the object of interest in the 3-D scenes; and (d) triggering selection of the semantic object using pointer selection within a region of the object of interest.

In one implementation, dragging object selection includes: (a) loading the 3-D scenes through the specified path; (b) selecting a group of splats using selection tools; and (c) moving the group of splats throughout to scene to the position of interest.

In one implementation, cloning object selection includes: (a) loading the 3-D scenes through the specified path; (b) selecting a group of splats using selection tools; and (c) copying and moving the group of splats throughout the 3-D scenes.

In one implementation, virtual camera manipulation and rendering includes: (a) importing virtual cameras from external sources; (b) adding new virtual cameras through the interactive viewer; and exporting the virtual camera data to the file and/or rendering images alongside the exported camera data.

Alternative implementations include: (a) extending rendering capability of the web viewer beyond Gaussian splatting to any view-dependent rendering methods; (b) extending 3-D object selection to work directly on explicit point cloud representations of the scene to support selection on any explicit view-dependent rendering method; (c) using the web viewer to render the Gaussian splatting representation through either interactive user interface or through command line, with specified virtual camera poses; (d) extending to support deselection and combination of selections using set rules (union, intersection and difference) on point cloud representations, in addition to selection.

Further, above-described implementations provide one or more of: (a) semantically and 3-D aware object selection from the Gaussian splatting scene, solely from the single pointer event; (b) integrated system of 3-D aware real-time shape selector and existing interactive viewers, camera manipulation and splatting export tools; and (c) an extensive set of object selection tools that (in a shape aware manner) select the objects of interest and can be corrected with high-quality 2-D segmentation model backends.

In a particular implementation, a method for selecting 3-D shapes in a 3-D scene representation for segmentation model is disclosed. The method includes: receiving parameters including virtual camera pose, 3-D scene view, and viewport location of the 3-D shapes including an object of interest; performing segmentation of the object of interest using the 3-D scene view and the viewport location of the object of interest; extracting a 2-D view of the object of interest using the segmented object of interest; performing segmentation of memory state of the extracted 2-D view; generating 3-D virtual camera poses around the object of interest using the extracted 2-D view and the virtual camera pose; performing segmentation of the object of interest using the 3-D scene views, the segmented memory state of the extracted 2-D view, and the 3-D virtual camera poses; and
extracting multiple 2-D views of the object of interest using the segmented object of interest.

In one implementation, selection of the 3-D shapes in a 3-D scene representation is performed by a web-based viewer/editor. In one implementation, the web-based viewer/editor is a standalone web application. In one implementation, the web application resides on a hardware mobile device for real-time visualization, editing and navigation throughout the 3-D scene representation. In one implementation, the method further includes visually hulling the object of interest by extracting the 3-D objects of interest in world coordinates using the multiple 2-D views.

In another particular implementation, a web-based viewing apparatus to select 3-D shapes in a 3-D scene representation for segmentation model is disclosed. The apparatus including: a segmentation system to receive rendered 3-D scene view and viewport location of the 3-D shape including an object of interest, and to perform segmentation of the object of interest using the rendered 3-D scene and the viewport location, the segmentation system to extract and output a 2-D view of the object of interest using the segmented object of interest; a 3-D virtual camera pose generator to generate 3-D virtual camera poses around the object of interest using the extracted 2-D view; and a pose renderer to render the generated 3-D virtual camera poses and to output 3-D scene views, wherein the segmentation system receives the 3-D scene views and extracts multiple 2-D views of the object of interest using the 3-D scene views and the 3-D virtual camera poses.

In one implementation, the 3-D scene representation includes Gaussian splatting representation. In one implementation, the web-based viewing apparatus is a standalone web application. In one implementation, the web application resides on a hardware mobile device for real-time visualization, editing and navigation throughout the 3-D scene representation. In one implementation, the apparatus further includes a visual hulling system to perform visual hulling of the object of interest and extract 3-D objects of interest in world coordinates using the multiple 2-D views of the object of interest.

In a further particular implementation, a method for selecting 3-D shapes including an object of interest in Gaussian splatting representation is disclosed. The method includes: performing segmentation of the object of interest of the 3-D shapes using 3-D scene view and viewport location of the object of interest; extracting a 2-D view of the object of interest using the segmented object of interest; performing segmentation of memory state of the extracted 2-D view; generating 3-D virtual camera poses around the object of interest using the extracted 2-D view; performing segmentation of the object of interest using the 3-D scene views, the segmented memory state of the extracted 2-D view, and the 3-D virtual camera poses; and extracting multiple 2-D views of the object of interest using the segmented object of interest.

In one implementation, the method further includes visually hulling the object of interest by extracting the 3-D objects of interest in world coordinates using the multiple 2-D views. In one implementation, the method further includes web viewing the 3-D scene view. In one implementation, web viewing the 3-D scene view comprises at least one of: navigating in real-time throughout the 3-D scene views; toggling change between color, depth and normal representation through underlying 3-D scenes; defining color complexity levels used for 3-D visualization when splats used in the Gaussian splatting representation are based on different color representations; manipulating the 3-D scenes including select, move, clone and delete objects; and exporting the manipulated 3-D scenes. In one implementation, the method further includes selecting a semantic object on the 3-D scenes. In one implementation, selecting the semantic object comprises at least one of: navigating in real-time throughout the 3-D scenes; finding the object of interest in the 3-D scenes; and triggering selection of the semantic object using pointer selection within a region of the object of interest. In one implementation, the method further includes cloning the selection of the semantic object. In one implementation, cloning the selection includes: selecting a group of splats using selection tools; and copying and moving the group of splats throughout the 3-D scenes.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for selecting 3-D shapes in a 3-D scene representation for segmentation model, the method comprising:
receiving parameters including virtual camera pose, 3-D scene view, and viewport location of the 3-D shapes including an object of interest;
performing segmentation of the object of interest using the 3-D scene view and the viewport location of the object of interest;
extracting a 2-D view of the object of interest using the segmented object of interest;
performing segmentation of memory state of the extracted 2-D view;
generating 3-D virtual camera poses around the object of interest using the extracted 2-D view and the virtual camera pose;
performing segmentation of the object of interest using the 3-D scene views, the segmented memory state of the extracted 2-D view, and the 3-D virtual camera poses; and
extracting multiple 2-D views of the object of interest using the segmented object of interest.

2. The method of claim 1, wherein selection of the 3-D shapes in a 3-D scene representation is performed by a web-based viewer/editor.

3. The method of claim 2, wherein the web-based viewer/editor is a standalone web application.

4. The method of claim 3, wherein the web application resides on a hardware mobile device for real-time visualization, editing and navigation throughout the 3-D scene representation.

5. The method of claim 1, further comprising
visually hulling the object of interest by extracting the 3-D objects of interest in world coordinates using the multiple 2-D views.

6. A web-based viewing apparatus to select 3-D shapes in a 3-D scene representation for segmentation model, the apparatus comprising:
a segmentation system to receive rendered 3-D scene view and viewport location of the 3-D shape including an object of interest, and to perform segmentation of the object of interest using the rendered 3-D scene and the viewport location,
the segmentation system to extract and output a 2-D view of the object of interest using the segmented object of interest;
a 3-D virtual camera pose generator to generate 3-D virtual camera poses around the object of interest using the extracted 2-D view; and
a pose renderer to render the generated 3-D virtual camera poses and to output 3-D scene views,
wherein the segmentation system receives the 3-D scene views and extracts multiple 2-D views of the object of interest using the 3-D scene views and the 3-D virtual camera poses.

7. The apparatus of claim 6, wherein the 3-D scene representation includes Gaussian splatting representation.

8. The apparatus of claim 6, wherein the web-based viewing apparatus is a standalone web application.

9. The apparatus of claim 8, wherein the web application resides on a hardware mobile device for real-time visualization, editing and navigation throughout the 3-D scene representation.

10. The apparatus of claim 6, further comprising
a visual hulling system to perform visual hulling of the object of interest and extract 3-D objects of interest in world coordinates using the multiple 2-D views of the object of interest.

11. A method for selecting 3-D shapes including an object of interest in Gaussian splatting representation, the method comprising:
performing segmentation of the object of interest of the 3-D shapes using 3-D scene view and viewport location of the object of interest;
extracting a 2-D view of the object of interest using the segmented object of interest;
performing segmentation of memory state of the extracted 2-D view;
generating 3-D virtual camera poses around the object of interest using the extracted 2-D view;
performing segmentation of the object of interest using the 3-D scene views, the segmented memory state of the extracted 2-D view, and the 3-D virtual camera poses; and
extracting multiple 2-D views of the object of interest using the segmented object of interest.

12. The method of claim 11, further comprising
visually hulling the object of interest by extracting the 3-D objects of interest in world coordinates using the multiple 2-D views.

13. The method of claim 11, further comprising
web viewing the 3-D scene view.

14. The method of claim 13, wherein web viewing the 3-D scene view comprises at least one of:
navigating in real-time throughout the 3-D scene views;
toggling change between color, depth and normal representation through underlying 3-D scenes;
defining color complexity levels used for 3-D visualization when splats used in the Gaussian splatting representation are based on different color representations;
manipulating the 3-D scenes including select, move, clone and delete objects; and
exporting the manipulated 3-D scenes.

15. The method of claim 14, further comprising
selecting a semantic object on the 3-D scenes.

16. The method of claim 15, wherein selecting the semantic object comprises at least one of:
navigating in real-time throughout the 3-D scenes;
finding the object of interest in the 3-D scenes; and
triggering selection of the semantic object using pointer selection within a region of the object of interest.

17. The method of claim 15, further comprising
cloning the selection of the semantic object.

18. The method of claim 17, wherein cloning the selection includes:
selecting a group of splats using selection tools; and
copying and moving the group of splats throughout the 3-D scenes.
